(19) United States
(12) Patent Application Publication
(10) Pub. No.: US 2026/0223794 A1
(43) Pub. Date: Aug. 6, 2026

(54) DEVICE AND METHOD FOR GROWING CLIMBING PLANTS, AND SYSTEM AND METHOD FOR GROWING AND HARVESTING CLIMBING PLANTS

(71) Applicant: FRAUNHOFER-GESELLSCHAFT ZUR FÖRDERUNG DER ANGEWANDTEN FORSCHUNG E.V., München (DE)

(72) Inventors: Simon VOGEL, Aachen (DE); Stefan SCHILLBERG, Aachen (DE)

(73) Assignee: FRAUNHOFER-GESELLSCHAFT ZUR FÖRDERUNG DER ANGEWANDTEN FORSCHUNG E.V., München (DE)

(21) Appl. No.: 19/149,923

(22) PCT Filed: Jan. 23, 2024
(86) PCT No.: PCT/EP2024/051472

§ 371 Date: Jul. 22, 2025

(30) Foreign Application Priority Data
Jan. 23, 2023 (EP) 23152953.8

(51) Int. Cl. A01G 31/04; A01G 22/05; A01G 31/02

(52) U.S. Cl. CPC A01G 31/047; A01G 22/05; A01G 31/025

(57) ABSTRACT

The invention relates to a device for growing climbing plants. The device comprises at least one tube having at least one opening for inserting climbing plants. The at least one opening is arranged in a wall of the tube. The device also comprises a holder element for holding the at least one tube. The at least one tube has a first end and a second end and is mounted, at its two opposing ends, on the holder element such that it can rotate about a longitudinal axis of the tube, so that at least one hanging part of the climbing plant can be wound over the at least one tube. The invention also relates to a method for growing climbing plants using the device, a system for growing and harvesting climbing plants including the device, and a method for growing and harvesting climbing plants using the system.

The invention relates to an apparatus for cultivating climbing plants, a method for cultivating climbing plants using the apparatus, a system for cultivating and harvesting climbing plants using the apparatus, and a method for cultivating and harvesting climbing plants using the system.

In recent years, more and more plants are being grown in a controlled environment, e.g., in a cultivation room or greenhouse, which is adapted to optimum growing conditions for the plants, such as temperature, humidity and light. The cultivation of agricultural products in fully air-conditioned cultivation rooms under the control of external influences is known as “indoor farming”.

Indoor farming primarily includes vertical farming (VF). Vertical farming (VF) is an extremely compact, vertical form of plant cultivation that enables highly efficient plant cultivation all year round. This form of cultivation has a fast harvest cycle, uses less fertilizer, nutrients and water, and is largely pesticide-free.

A vertical farming apparatus for cultivating plants is described, for example, in WO 2018/220011 (Orbiplant). The apparatus comprises a conveyor belt with horizontal and vertical sections that can be moved along a conveyor section, with the horizontal and vertical sections alternating along the conveyor section. The plants are fixed to the conveyor belt and are at least temporarily illuminated by a light source and supplied with nutrients and water while the conveyor belt is moving. However, the apparatus according to WO 2018/220011 is not suitable for the cultivation of long climbing plants, such as cucumbers, peas, runner beans, goldenrods, hops and passion flowers.

The vines of climbing plants can reach several meters, e.g., 4 to 5 meters, in a hanging form. During a growth cycle lasting several months, some of the climbing plants ripen every day and their fruit must be harvested in good time. If the climbing plants are grown in the apparatus according to WO 2018/220011, some of the climbing plants accumulate in a lower horizontal section, while the conveyor belt moves from a preceding higher horizontal section via an intermediate vertical section to the lower horizontal section. This not only makes harvesting the fruit more difficult, but can also lead to the climbing plants becoming entangled.

Until now, the climbing plants have been cultivated by manually pulling the vines onto a support structure as a climbing aid. Outdoors or in cultivation rooms, the vines are often pulled vertically upwards onto a trellis. Alternatively, the climbing plants can be cultivated horizontally in a shelving system according to JP 2016168016 A, with each climbing plant occupying one shelf level of the shelving system. The two common solutions for growing climbing plants require a lot of manual work and take up a relatively large amount of space.

Another important aspect of climbing plants is the harvest. Both in the field and in cultivation rooms, harvesting is often done by hand, which is very labor-intensive. However, existing harvesting robots fail due to difficulties with optical image recognition and free access to the fruits of the climbing plants. This is because the fruits are covered by numerous leaves, which makes it difficult for the harvesting robots to visually recognize the fruits and reach them.

Based on the apparatuses known from the prior art and the problems explained above, the invention is based on the object of providing an apparatus for cultivating climbing plants which enables space-saving cultivation of climbing plants, as well as providing a system for cultivating and harvesting climbing plants which facilitates harvesting.

The above problem is solved with an apparatus for cultivating climbing plants according to claim 1 and with a system for cultivating and harvesting climbing plants according to claim 15. A method of cultivating climbing plants using the apparatus is disclosed in claim 13. A method of cultivating and harvesting climbing plants using the system is disclosed in claim 16. Further advantageous embodiments and designs of the invention are the subject of the dependent claims.

The invention relates to a apparatus for cultivating climbing plants, which comprises at least one tube. The tube has a first end and a second end along a tube axis. The tube axis can be understood as a straight line that extends in the longitudinal direction of the tube. Advantageously, the tube can be cylindrical. In this case, the tube axis is the cylinder axis. The base of the cylindrical shape can be of any shape, but a circular base is preferred.

The tube has at least one opening in one wall of the tube. The tube wall can be regarded as the outer shell of the tube. It runs around the longitudinal axis of the tube. In the case of a cylindrical tube, the tube wall is the lateral surface of the cylindrical shape. The opening is arranged in such a way that at least one climbing plant can be inserted in it. The climbing plants can have roots, leaves, vines and fruit, for example. The fact that a plant can be inserted into one of the openings means that at least the roots of the plant can be inserted into the opening with or without a substrate or a holder. The tube can be used to achieve a spatial separation of the roots from the leaves and vines, as the roots remain inside the tube while the leaves and vines grow outside the tube, for example in a hanging form. This type of spatial separation enables a better controllable and adjustable atmosphere and prevents excessive humidity during the cultivation of climbing plants.

The apparatus also comprises a holding device for holding the at least one tube. The two opposite ends of the tube, i.e., the said first and second ends of the tube, are mounted on the holding device so as to be rotatable about a longitudinal axis of the tube, so that at least a hanging part of the climbing plants can be wound up over the tube.

The climbing plants generally have cultivation and harvest cycles of several months. When the fruits are harvested in a harvest cycle, the vines already reach a certain length. By turning the tube, the harvested tendril sections closer to the roots can be wound up over the tube, shortening the length of the remaining hanging tendril sections. These can then form a shoot tip area with new flower buds and future fruits in the next cultivation and harvest cycle.

Instead of presenting the entire length of the climbing plants during the cultivation and harvesting cycles, according to the invention only a crop-bearing part of the climbing plants is presented with a shortened predetermined length, which reduces the cultivation area and favors or facilitates the subsequent harvesting.

In an advantageous embodiment of the invention, the tube can be arranged at an angle of inclination to a horizontal direction. Preferably, the angle of inclination is greater than or equal to 1 degree, preferably greater than or equal to 5 degrees, preferably greater than or equal to 10 degrees, preferably greater than or equal to 15 degrees, preferably greater than or equal to 20 degrees, and/or less than or equal to 45 degrees, preferably less than or equal to 40 degrees, preferably less than or equal to 35 degrees, preferably less than or equal to 30 degrees, preferably less than or equal to 25 degrees. The angle of inclination is preferably greater than or equal to 4 degrees and less than or equal to 8 degrees.

In an advantageous embodiment, the retaining element can comprise two legs, whereby at least one of the two legs is particularly preferably height-adjustable in a vertical direction. Preferably, the at least one tube can be arranged with an angle of inclination greater than zero. If one of the legs is adjustable, the angle of inclination can be set by changing the length of this leg.

An inclined arrangement of the tube is particularly suitable for hydroponic supply, as the nutrient solution flows independently through the tube due to the angle of inclination, so that all roots inside the tube are supplied with the nutrient solution. In particular, if the climbing plants are supplied aeroponically, an inclined arrangement is not necessary.

In a further advantageous embodiment of the invention, the tubes can each comprise a first opening at their first end and a second opening at their second end.

In an advantageous embodiment, the apparatus can have an irrigation unit which is set up to introduce nutrient solution into at least one of the tubes in each case, advantageously through the first opening. The first opening can therefore be an inlet for the nutrient solution. The apparatus according to the invention can comprise, for example as part of the irrigation unit, a collecting element which can be arranged at the second opening in such a way that nutrient solution emerging through the second opening can be collected or collected in the collecting element. The second opening forms an outlet for the nutrient solution.

The first and second openings in the tube effectively prevent unwanted waterlogging. Waterlogging occurs when climbing plants are watered excessively and the water does not drain away in time. As a result, the roots remain in the moist substrate or support for a long time and the climbing plants can no longer absorb oxygen and nutrients through the roots. In another advantageous embodiment of the invention, the irrigation unit may comprise a pump, a first conduit, and a tank. A first end of the first conduit may be connected to the pump, while a second end of the first conduit may be arranged at the first opening of at least one of the tubes. The pump can be connected to the tank in such a way that the nutrient solution can be conveyed from the tank through the first conduit to the first opening by means of the pump.

Particularly preferably, the pump can be arranged such that the nutrient solution can be conveyed from the tank through the first conduit to the first opening. The arrangement of the pump and the first conduit enables an automatic and precise supply to the roots without unnecessarily moistening the leaves and fruit.

In an advantageous addition to the previously described embodiment, the irrigation unit can have a second conduit. A first end of the second conduit can be connected to the collecting element, while a second end of the second conduit can be connected to the tank, preferably arranged in the tank. The second conduit can be set up so that the nutrient solution collected in the collecting funnel can be returned to the tank. This recycles the superfluous nutrient solution and reduces nutrient solution consumption. Advantageously, the first end of the second conduit can be arranged higher than the second end of the second conduit, so that the nutrient solution can be returned to the tank under the effect of gravity.

A further advantageous embodiment of the invention provides that the apparatus comprises a plurality of the tubes which are arranged at least partially one above the other in a vertical direction. In this configuration, a larger number of climbing plants can be cultivated, as the vertical space is efficiently utilized by the apparatus. It is generally conceivable to cultivate both the same type of climbing plants and different types of climbing plants in the tubes.

Preferably, it can also be provided that the tubes are arranged parallel to each other, i.e., either in the horizontal direction or at the same angle of inclination to the horizontal direction. The fact that the tubes can be arranged parallel to each other means that their tube axes are parallel to each other.

It is particularly advantageous that the tubes can be moved in a vertical direction by a transport unit of the apparatus. This allows the respective heights of the tubes to be adapted to the different growth and harvest cycles of the climbing plants in order to meet the increasing space requirements of the growing climbing plants. For example, those climbing plants that are soon to be harvested can be set to a suitable height for harvesting. After the harvesting process, the harvested tendril sections can be wound up over the tube and the tube can then be moved to a different height to wait for the next harvesting cycle. Furthermore, the individual tubes can be irrigated by the irrigation unit at a height suitable and adapted for irrigation.

In a further advantageous embodiment, the transport unit can have two tensile transmission devices, which can also be referred to as tensile force transmission devices, preferably transport chains, transport bands or transport belts. A first of the tension transmission devices may extend at least in sections in the vertical direction at the first ends of the tubes, while a second of the tension transmission devices may extend at least in sections in the vertical direction at the second ends of the tubes. Preferably, the first tension transmission device can run parallel to the second.

The tension transmission devices may, for example, comprise a plurality of brackets at different heights in the vertical direction, on which the tubes are mounted horizontally or with an equal angle of inclination to the horizontal direction at their opposite ends so that they can be rotated about the longitudinal axes of the tubes, so that hanging parts of the climbing plants can be wound up over the tubes.

In a particularly advantageous embodiment of the invention, the transport unit can have at least four deflection rollers. The first tension transmission device can then run over an upper and a lower deflection roller, and the second tension transmission device can also run over an upper and a lower deflection roller. The terms “upper” and “lower” are to be understood as meaning that the corresponding deflection rollers are arranged higher or lower than the other roller of the same tension transmission device when the apparatus is installed as intended. The tension transmission devices can describe a closed path. Each of the two tension transmission devices may comprise two vertical sections, an upward movement section and an opposite downward movement section. In the region of the respective deflection rollers, the tension transmission sections can run along the circumference of the corresponding rollers. These sections then connect the two vertical sections with each other.

Optionally, two of the deflection rollers, over which different of the tension transmission devices run, are arranged at the same height. For example, the first deflection roller and the third deflection roller can be arranged at a common height on the retaining element, while the second deflection roller and the fourth deflection roller are arranged at a different common height on the retaining element. This arrangement enables a mirror-symmetrical structure of the transport unit and provides high stability and robustness.

It is preferable that two corresponding deflection rollers, for example the first and third deflection rollers and the second and fourth deflection rollers, are arranged at different heights on the retaining element. Preferably, the two upper deflection rollers can therefore be arranged at different heights and the two lower deflection rollers can be arranged at different heights. Preferably, the distance between the deflection rollers of the same tension transmission device, i.e., the distance between the lower and the upper deflection roller, is the same for both tension transmission devices. In this way, the angle of inclination of the tubes remains unchanged when the tubes are moved by the tension transmission devices. In this way, the direction of inclination of the tubes is maintained during transportation of the tubes through the tension transmission devices. To further increase stability, the apparatus can include additional transport rollers, which are arranged between the top and bottom deflection rollers and over which the tension transmission devices run.

In an advantageous embodiment of the invention, the apparatus can have at least one motor which is set up to drive at least one of the deflection rollers, preferably one deflection roller of each tension transmission device, in such a way that the tubes can be moved in the vertical direction. The direction from the lower to the upper deflection rollers can be regarded as the vertical direction. The motor realizes an automatic vertical movement of the tubes. Preferably, the motor is controlled by a control unit in such a way that the speed of the vertical movement of the tubes is regulated in a predetermined manner.

In addition to the apparatus for cultivating climbing plants, the invention relates to a method for cultivating climbing plants using the apparatus.

In the method according to the invention, the climbing plants are each inserted into an opening of the at least one tube. After the plants have grown accordingly, the at least one tube is rotated to wind a hanging part of the climbing plants over the at least one tube.

In principle, climbing plants can be cultivated with or without a substrate and/or a support. If the climbing plants are placed in the opening without a substrate, they are preferably supplied with nutrients and water aeroponically, i.e., via the air. Aeroponics is a cultivation method for plants in which the plants are fixed in such a way that the roots inside the tube are wetted with an aerosol of a hydroponic fertilizer solution consisting of nutrients and water. The hydroponic fertilizer solution can be atomized using atomizers, e.g., low-pressure, high-pressure and ultrasonic atomizers, which are arranged in the tube.

If the climbing plants are placed in the opening with a substrate, they are preferably supplied with nutrient solution hydroponically by introducing the nutrient solution into the tube through one of the end openings of the tube. A suitable substrate can be rock wool or a comparable carrier material in which the roots are fixed. Preferably, the substrate is selected in such a way that the roots are well supported and the substrate can transfer the nutrient solution and store it at least temporarily.

At least one tube can be turned manually. Alternatively, the at least one tube can also be rotated automatically, for example electrically. As the tube can be rotated, the hanging length of the climbing plants can be shortened, saving space for cultivation.

Advantageously, the at least one tube is rotated in such a way that the at least one opening for inserting climbing plants is arranged after rotation in such a way that nutrient solution cannot flow out of the tube through the opening, i.e., preferably in a lateral or preferably upper tube region. In this way, the nutrient solution can be prevented from leaking through the at least one opening for inserting the climbing plants. In the case of automatic rotation, the desired angle of rotation of the at least one tube can also be controlled or monitored via a control unit.

In an advantageous embodiment of the invention, the tube or tubes can each be arranged on the corresponding tension transmission device via a retaining element. The retaining element can be arranged on the corresponding tension transmission device via a bearing, preferably a ball bearing. The retaining element can advantageously have two legs adjoining each other at an angle, preferably at right angles. A first of the legs can be arranged on the bearing, while a second of the legs can have a swivel joint with a locking mechanism at its end facing away from the first leg. The corresponding tube can be arranged on the second leg of the retaining element on the swivel joint with locking mechanism in such a way that it can be rotated by the swivel joint when the locking mechanism is released. This arrangement causes the second leg of the retaining element to point downwards by gravity in any position along the movement through the tension transmission device, so that the tube does not change its orientation around the tube axis during the movement through the tension transmission device. On the other hand, the tube can be rotated around the tube axis in the swivel joint with locking mechanism in order to wind up hanging parts of the plants. In this embodiment, it is advantageous if the tubes are shorter than the distance between the tension transmission devices, as the tubes then do not collide with the tension transmission devices.

The invention also relates to a system for cultivating and harvesting climbing plants. The system comprises the apparatus according to the invention, a illumination device arranged on a first side of the apparatus for illuminating the climbing plants, and a harvesting robot arranged on a side of the apparatus opposite the first side for harvesting the climbing plants. Preferably, the harvesting robot can be arranged opposite the illumination device with respect to a plane spanned by at least two of the tube axes or with respect to a plane in which at least one tube axis of one of the tubes and at least one hanging component of a climbing plant arranged in this tube is arranged. The apparatus can therefore be arranged between the harvesting robot and the illumination device. The illumination device can illuminate a plane that is spanned by at least two of the tube axes.

In an advantageous embodiment, the illumination device enables targeted and controlled irradiation of the climbing plants with suitable wavelengths. It is also conceivable to adapt the lighting of the illumination device to the respective requirements of the climbing plants in different growth phases.

Due to the one-sided lighting, the leaves of the climbing plants are aligned towards the side facing the light, while the fruits of the climbing plants are presented for harvesting on the side facing away from the light, where the harvesting robot is located. The one-sided lighting causes the leaves to grow towards the illumination device to maximize photosynthetic energy and promote growth.

One idea of this embodiment of the system for cultivating and harvesting climbing plants according to the invention is thus to utilize the phototropism of the climbing plants. The leaves of the plants are directed towards the light. This means that the fruit on the opposite side is not obscured by leaves. This gives the harvesting robot free access to the fruit so that failures due to difficulties in the optical image recognition of the fruit by the harvesting robot can be greatly reduced.

It is also possible to remove shoot tips of the climbing plants that are directed towards the light-facing side to enable a more homogeneous longitudinal growth of the main shoot of the climbing plants so that the climbing plants do not overgrow. In addition, pruning the shoot tips promotes the health of the climbing plants. Since higher secondary metabolite concentrations are often found in shoot tips, the removed shoot tips of the climbing plants can also be used as secondary target products in such cases.

In one embodiment, it may be provided that the harvesting robot is designed for harvesting the climbing plants on the side of the apparatus opposite the first side and/or for harvesting the climbing plants, in particular shoot tips of the climbing plants, on the first side of the apparatus. Alternatively or additionally, the system may comprise a further harvesting robot for harvesting climbing plants, in particular shoot tips of the climbing plants, which is arranged on the first side of the apparatus between the illumination device and the apparatus. The harvesting of climbing plants disclosed in this document may comprise harvesting only one climbing plant, harvesting at least one climbing plant or harvesting a plurality of climbing plants. The same applies to harvesting the shoot tips.

In this context, the system for cultivating and harvesting climbing plants may comprise a cutting tool for harvesting shoot tips of the climbing plants. The cutting tool can be part of the harvesting robot and/or the other harvesting robot. Advantageously, the cutting tool is arranged on the first side of the apparatus between the illumination device and the apparatus. In particular, the cutting tool or the respective harvesting robot can enable automatic vertical cutting in order to harvest the shoot tips of the climbing plants growing towards the illumination device.

In addition to the system for cultivating and harvesting climbing plants, the invention also relates to a method for cultivating and harvesting climbing plants using the system.

In the method according to the invention, the climbing plants are each inserted into an opening in one of the tubes. On the first side of the apparatus, the climbing plants are illuminated by the illumination device. When the fruits of the climbing plants are ripe in a harvest cycle, the climbing plants are harvested by the harvesting robot on the side of the apparatus opposite the first side. The corresponding tube is then rotated to wind the harvested hanging part of the climbing plants over the corresponding tube. Twisting significantly shortens the length of the remaining hanging tendril sections. In the next cultivation and harvest cycle, these then form a shoot tip area with new flower buds and future fruits. The above-mentioned process steps relating to lighting, harvesting and turning can be repeated in subsequent harvesting cycles.

In an advantageous embodiment, the method may comprise harvesting shoot tips of the climbing plants on the first side of the apparatus. The shoot tips of the climbing plants can be harvested using a cutting tool and/or the harvesting robot and/or the system's other harvesting robot. When harvesting the shoot tips, it is advantageous to harvest the shoot tips of the climbing plants after harvesting the fruit of the climbing plants and before turning the tube. For this purpose, the harvesting robot can move from the original location, namely from the side of the apparatus opposite the first side, to the first side of the apparatus in order to harvest the shoot tips of the climbing plants. After harvesting the shoot tips of the climbing plants, the corresponding tube is then rotated in order to wind the harvested hanging part without the shoot tips of the climbing plants over the corresponding tube. The two harvesting processes, i.e., harvesting the fruit and the shoot tips, particularly promote new flower sets and future fruit in the next cultivation and harvesting cycle.

However, if a further harvesting robot is used, the further harvesting robot is preferably arranged on the first side of the apparatus between the illumination device and the apparatus. In this case, the harvesting of the shoot tips of the climbing plants on the first side of the apparatus is independent of the harvesting of the fruits of the climbing plants on the side of the apparatus opposite the first side. This enables more flexible harvesting of the shoot tips of the climbing plants.

In a further advantageous embodiment, the harvesting of the shoot tips of the climbing plants and the harvesting of the fruits of the climbing plants can take place simultaneously on both sides of the apparatus in order to reduce the harvesting time.

In the following, the invention is explained in more detail, without limiting the general idea of the invention, by means of examples of embodiments and with reference to the figures. Identical reference numerals denote identical or corresponding features. The features can also be realized independently of the specific example and can be combined between the examples. Shown are:

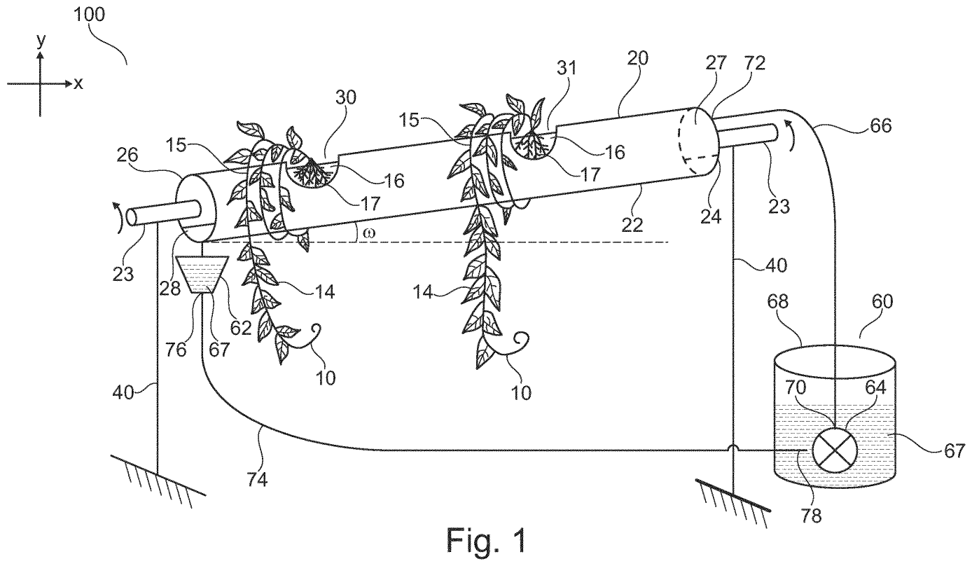

FIG. 1: a schematic representation of an apparatus according to the invention for cultivating climbing plants with a tube;

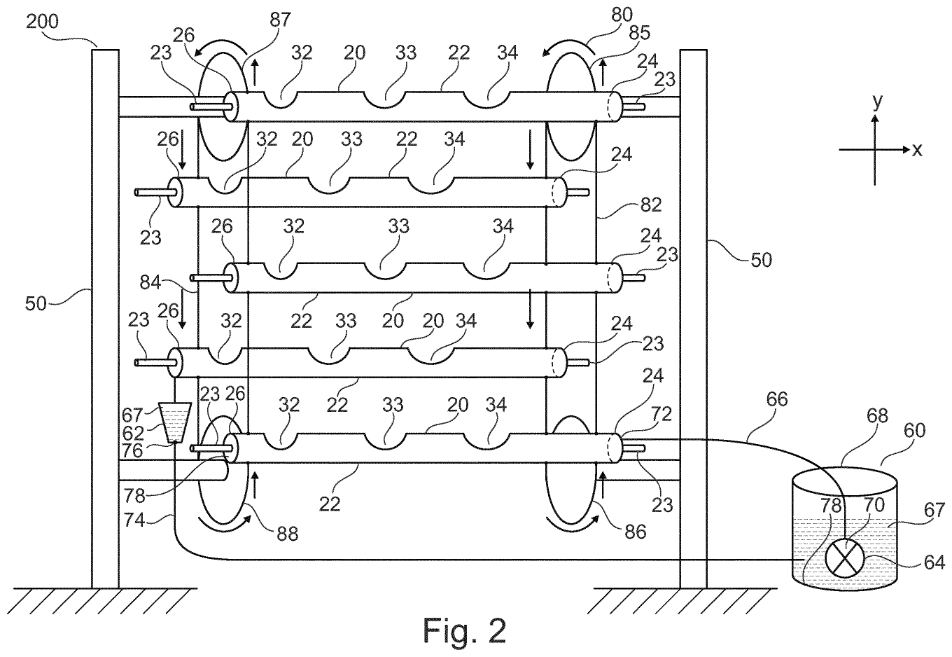

FIG. 2: a schematic representation of an apparatus according to the invention for cultivating climbing plants with a plurality of tubes;

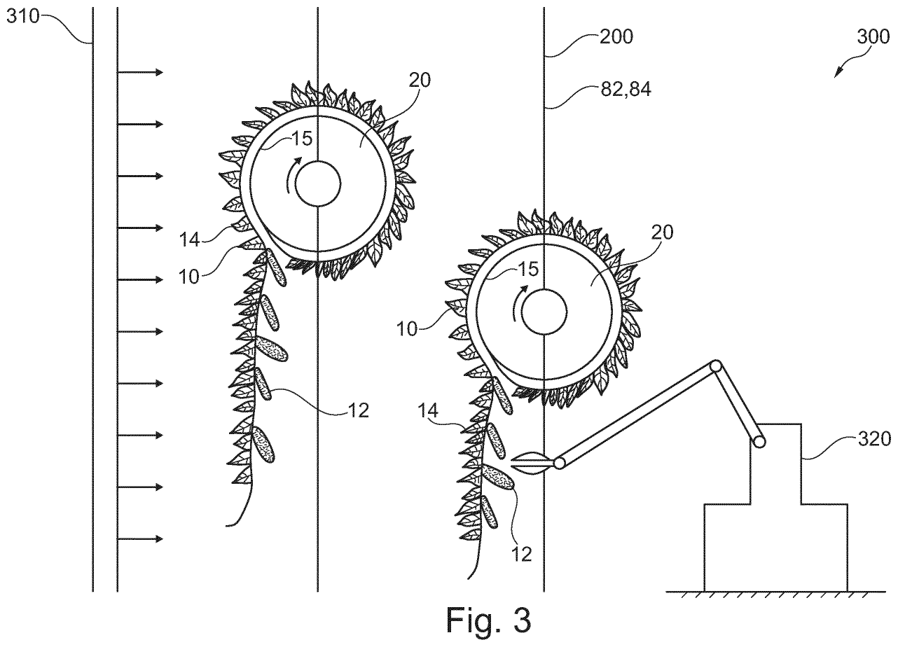

FIG. 3: a schematic representation of a system according to the invention for cultivating and harvesting climbing plants using the apparatus shown in FIG. 2;

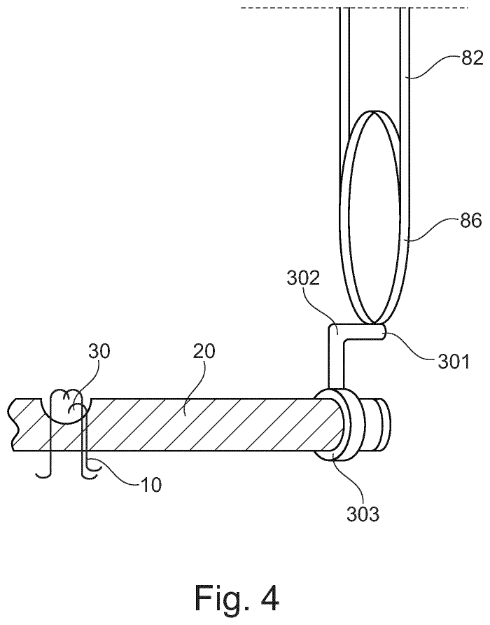

FIG. 4: an example of an attachment of the tubes to tension transmission devices;

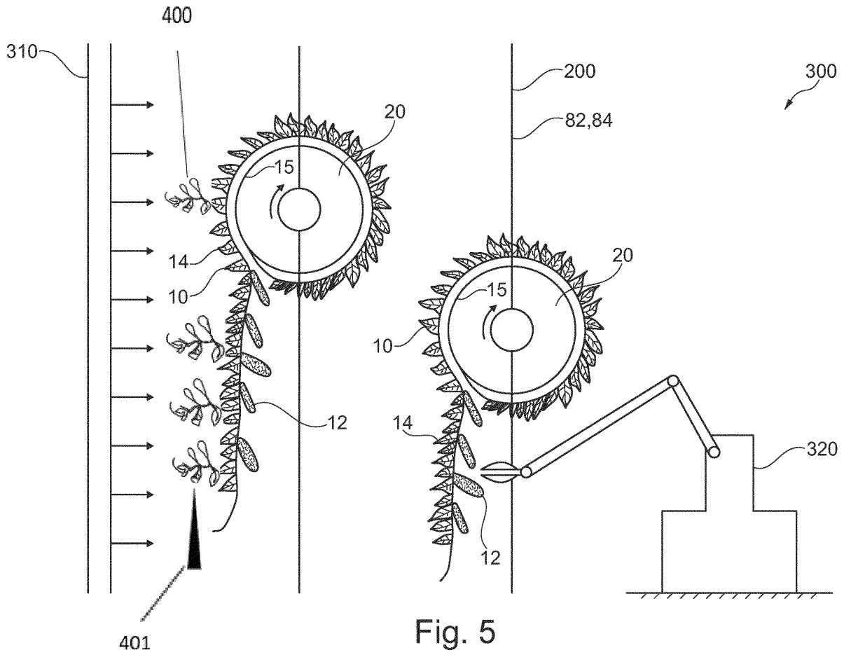

FIG. 5: a schematic representation of a further system according to the invention for cultivating and harvesting climbing plants using the apparatus shown in FIG. 2.

FIG. 1 schematically shows an apparatus 100 according to the invention for cultivating climbing plants 10. In this example, the apparatus 100 comprises a tube 20 with two openings 30 and 31 for inserting climbing plants 10. The openings 30 and 31 are arranged in a tube wall 22 of the tube 20. The climbing plants 10 are inserted into the openings 30 and 31 with rock wool 16, in which the roots 17 are fixed. The leaves 14 and the vines 15 of the climbing plants 10 are located outside the openings 30 and 31. Part of the vines 15, which is closer to the roots 17, is wound up over the tube 20, while another part of the vines 15, which is further away from the roots 17, grows hanging. In addition to the openings 30 and 31 for inserting climbing plants 10, the tube 20 comprises a first end opening 27 at a first end 24 and a second end opening 28 at a second end 26. The tube 20 can have a circular, square or hexagonal cross-section, for example. If the tube 20 has a circular cross-section, it can have a diameter of 20 to 30 cm, preferably 25 cm, for example.

The apparatus 100 also comprises a retaining element 40 for holding the tube 20. The tube 20 is mounted at its two opposite ends 24, 26 on the retaining element 40 so as to be rotatable about a longitudinal axis of the tube 20, so that a hanging part of the climbing plants 10 can be wound up over the tube 20. The tube 20 can be rotated manually, for example by means of a handle 23 arranged at the end 24 or 26 of the tube 20.

Alternatively, the tube 20 can be rotated automatically, e.g., electrically, e.g., using an electric motor (not shown in FIG. 1). The tube 20 is arranged at an angle of inclination w greater than zero to a horizontal direction x on the retaining element 40. In the example shown, the angle of inclination w is greater than or equal to 4 degrees and less than or equal to 8 degrees. If the climbing plants 10 are supplied aeroponically, the tube 20 can also be arranged horizontally.

The apparatus 100 also comprises an irrigation unit 60. The irrigation unit 60 includes a pump 64, a first conduit 66, a second conduit 74, a tank 68 and a collection funnel 62. A first end 70 of the first conduit 66 is connected to the pump 64, and a second end 72 of the first conduit 66 is disposed at the first opening 27. The pump 64 is arranged in the tank 68 such that nutrient solution 67 can be delivered from the tank 68 through the first conduit 66 to the first end opening 27 in the tube 20. The collecting funnel 62 is arranged at the second end opening 28 in such a way that the nutrient solution 67 exiting through the second end opening 28 can be collected or collected in the collecting funnel 62. The first end opening 27 forms an inlet for the nutrient solution, while the second end opening 28 forms an outlet for the nutrient solution. A first end 76 of the second conduit 74 is connected to the collection funnel 62, and a second end 78 of the second conduit 74 is disposed in the tank 68. The first end 76 of the second conduit 74 is arranged higher in a vertical direction y than the second end 78 of the second conduit 74, so that the nutrient solution 67 can be returned to the tank 68 under the action of gravity.

FIG. 2 schematically shows an apparatus 200 according to the invention for cultivating climbing plants 10. The apparatus 200 differs from the apparatus 100 according to FIG. 1 in that the apparatus 200 comprises a plurality of the tubes 20 and a transport unit 80 for moving the tubes 20 in the vertical direction y. In addition, the tubes 20 have three openings 32, 33 and 34 for inserting climbing plants 10 (not shown in FIG. 2). The openings 32, 33 and 34 are also arranged in the tube walls 22 of the tubes 20. The climbing plants 10 can be inserted into the openings 32, 33 and 34 without or with the rock wool 16 as described in FIG. 1.

The transport unit 80 comprises two tension transmission devices 82, 84, preferably transport chains, transport bands or transport belts. A first 82 of the tension transmission devices 82, 84 extends at least in sections in the vertical direction y at the first ends 24 of the tubes 20, and a second 84 of the tension transmission devices 82, 84 extends at least in sections in the vertical direction y at the second ends 26 of the tubes 20.

The tubes 20 are arranged in the vertical direction y one above the other and parallel to each other on the tension transmission devices 82, 84. The tubes 20 are preferably arranged equidistantly to one another, measured along the tension transmission device 82, 84. In this context, the tension transmission devices 82, 84 comprise a plurality of supports at different heights on which the tubes 20 are mounted either horizontally or at an equal angle of inclination w to the horizontal direction x at their opposite ends 24, 26 so as to be rotatable about the longitudinal axes of the tubes 20, so that hanging parts of the climbing plants 10 can be wound up over the tubes 20.

Advantageously, the tubes 20 can be arranged on the tension transmission devices 82, 84 via ball bearings. For example, a retaining element (not shown in FIG. 2) can be provided for each tube on each side of the tube 20, which is connected to the corresponding tension transmission device 82, 84 via a ball bearing and on which the corresponding tube 20 is locked. Advantageously, the retaining element can be shaped in such a way that the corresponding tube is held with its tube axis parallel and at a distance greater than zero to an axis of rotation of the corresponding ball bearing. In this way, the tube 20 hangs downwards in any position along the tension transmission devices 82, 84 opposite the two ball bearings and maintains its alignment. In this way, the tubes 20 are not rotated by the movement of the tension transmission device 82, 84.

The transport unit 80 also comprises four deflection rollers 85, 86, 87, 88. The apparatus 200 comprises a retaining element 50 for holding the four deflection rollers 85, 86, 87, 88. The first tension transmission device 82 runs over the first, upper deflection roller 85 and the second, lower deflection roller 86, and the second tension transmission device 84 runs over the third, upper deflection roller 87 and the fourth, lower deflection roller 88. Due to the deflection rollers 85, 86, 87, 88, the tension transmission devices 82, 84 can be moved along a corresponding closed path. The first tension transmission device 82 comprises two vertical sections consisting of an up-movement section and a down-movement section opposite the up-movement section, and two curved sections in the region of the upper 85 and lower deflection roller 86, which connect the vertical up-movement section and the vertical down-movement section to one another. The second tension transmission device 84 also comprises two vertical sections, which have an upward movement section and a downward movement section opposite the upward movement section, and two curved sections in the region of the upper 87 and lower deflection roller 88, which connect the vertical upward movement section and the vertical downward movement section to one another.

The tubes 20 can advantageously be somewhat shorter than a distance between opposing deflection rollers 80, 87 or 86, 88 or a distance between the tension transmission devices 82, 84. In this way, the tubes are held between the tension transmission devices 82, 84. This arrangement can be achieved using the retaining element described above, for example.

For the vertical movement of the tubes 20, the apparatus 200 comprises a motor (not shown in FIG. 2). The motor is arranged to drive at least one of the deflection rollers 85, 86, 87, 88, preferably one deflection roller of each tension transmission device, in such a way that the tubes 20 are moved in the vertical direction y. Furthermore, the motor can be controlled via a control unit in order to regulate or control a speed of the vertical movement of the tubes 20.

The apparatus 200 further comprises the irrigation unit 60, by means of which one of the tubes 20 can be irrigated at a height suitable for irrigation, for example at a lowest height. As the tubes move through the tension transmission device, all tubes 20 move past the opening 72 of the conduit 66 and can thus be watered one after the other.

It is optionally possible for the first, upper deflection roller 85 and the third, upper deflection roller 87 to be arranged at a common height on the retaining element 50, while the second, lower deflection roller 86 and the fourth, lower deflection roller 88 are arranged at a different common height on the retaining element 50. Thus, the transport unit 80 has a mirror-symmetrical structure that is relatively stable and robust.

Advantageously, the first, upper deflection roller 85 and the third, upper deflection roller 87 can be arranged at different heights on the retaining element 50, while the second, lower deflection roller 86 and the fourth, lower deflection roller 88 can be arranged at other different heights on the retaining element 50. Preferably, a distance between the heights of the first deflection roller 85 and the third deflection roller 87 is equal to a distance between the heights of the second deflection roller 86 and the fourth deflection roller 88. In this arrangement, the angle of inclination of the tubes 20 remains unchanged as the tubes 20 move from the vertical sections through the curved sections to the opposite vertical sections of the tension transmission devices 82, 84. In particular, this allows the tubes 20 in the two opposite vertical sections of the tension transmission devices 82, 84 to be irrigated without having to exchange a position of the inlet 72 of the nutrient solution 67 and a position of the outlet 28 of the nutrient solution 67.

FIG. 3 schematically shows a system 300 according to the invention for cultivating and harvesting climbing plants 10. The system 300 comprises the apparatus 200 according to FIG. 2 with the climbing plants 10 inserted into the openings 32, 33, 34 of the tubes 20. The system 300 further comprises a illumination device 310 arranged on a first side of the apparatus 200 for illuminating the climbing plants 10. In particular, the illumination device 310 can illuminate the climbing plants 10 in a targeted and controlled manner with suitable wavelengths and/or adapt them to the respective requirements of the climbing plants 10 in different growth phases. The system 300 further comprises a harvesting robot 320 arranged on a side of the apparatus 200 opposite to the first side for harvesting the climbing plants 10.

Due to the one-sided illumination, the leaves 14 of the climbing plants 10 are oriented towards the side facing the light, where the illumination device 310 is located, while the fruits 12 of the climbing plants 10 are presented for harvesting on the side facing away from the light, where the harvesting robot 320 is located. Since the distances between the leaves 14 and the fruits 12 are relatively large and the leaves 14 do not cover the fruits 12, the fruits 12, in this case the cucumbers, are easily recognized from the side facing away from the light by optical image recognition of the harvesting robot 320 and can then be successfully harvested by the harvesting robot 320.

The system 300 therefore allows the harvesting robot 320 free accessibility to the fruits 12 and reduces failures due to difficulties in optical image recognition of the fruits 12 by the harvesting robot 320.

FIG. 4 shows an example of one way of attaching the tubes 20 to the tension transmission devices 82, 84. This configuration is advantageous because it does not change the orientation of the tubes about their tube axis when they are moved by means of the tension transmission devices 82, 84.

Only one tube 20 is shown here on one of the tension transmission devices 82, but the other tubes 20 can be attached in the same way and the attachment to the other tension transmission device 84 can also be designed in the same way. A retaining element 302 is arranged here on the tension transmission device 82 via a ball bearing 301. The retaining element 302 has two legs adjoining each other at an angle, preferably at right angles. The first of the legs is arranged on the ball bearing 301, while the second leg has a swivel joint with a locking mechanism 303 at its end facing away from the first leg. The tube 20 is arranged on the second leg of the retaining element 302 via the swivel joint with locking mechanism 303. This arrangement causes the second leg of the retaining element 302 to point downwardly by gravity in any position along the movement through the tension transmission device 82, so that the tube 20 does not change its orientation about the tube axis during the movement through the tension transmission device 82. On the other hand, the tube 20 can be rotated around the tube axis in the swivel joint with locking mechanism 303 in order to wind up hanging parts of the plants 10.

FIG. 5 shows a further embodiment of the system 300. FIG. 5 differs from FIG. 3 only in that a cutting tool 401 is present. The cutting tool 401 can be part of the harvesting robot 320 or another harvesting robot. With the embodiment of FIG. 5, it is possible in particular to remove shoot tips 400 of the climbing plants 10, which are oriented towards the side facing the light, in order to enable a more homogeneous longitudinal growth of the main shoot of the climbing plants 10, so that the climbing plants 10 do not overgrow. In addition, pruning promotes the health of the climbing plants 10. Since higher secondary metabolite concentrations are often found in shoot tips 400, the removed shoot tips 400 of the climbing plants 10 can also be used as secondary target products in such cases.

In the embodiment of FIG. 5, it may be provided that the harvesting robot 320 is configured for harvesting the climbing plants 10 on the side of the apparatus 200 opposite the first side and/or for harvesting the climbing plants 10, in particular shoot tips 400 of the climbing plants 10, on the first side of the apparatus 200. Alternatively or additionally, the system 300 may comprise a further harvesting robot for harvesting climbing plants 10, in particular shoot tips 400 of the climbing plants 10, which is arranged on the first side of the apparatus 200 between the illumination device 310 and the apparatus 200.

Advantageously, the cutting tool 401 is arranged or can be arranged on the first side of the apparatus 200 between the illumination device 310 and the apparatus 200. In particular, the cutting tool 401 or the respective harvesting robot can enable an automatic vertical cut to harvest the shoot tips 400 of the climbing plants 10 growing towards the illumination device 310.

### LIST OF REFERENCE SIGNS

apparatus 100, 200
climbing plants 10
fruits 12
leaves 14
vines 15
roots 17
rock wool 16
tube 20
tube wall 22
handle 23
first end of the tube 24
second end of the tube 26
first opening 27
second opening 28
openings 30, 31, 32, 33, 34
retaining element 40, 50
irrigation unit 60
pump 64
first end of the first conduit 70
second end of the first conduit 72
nutrient solution 67
tank 68
collecting funnel 62
second conduit 74
first end of the second conduit 76
second end of the second conduit 78
transport unit 80
tension transmission device 82, 84
deflection rollers 85, 86, 87, 88
system 300
illumination device 310
harvesting robot 320
ball bearing 301
retaining element 302
swivel joint with locking mechanism 303
shoot tips of climbing plants 400
cutting tool 401 inclination angle w horizontal direction x
vertical direction y

1-19. (canceled)

20. An apparatus for cultivating climbing plants, comprising:
at least one tube,
wherein the at least one tube has a first end and a second end along a tube axis,
wherein the at least one tube has at least one opening for inserting climbing plants,
wherein the at least one opening is arranged in a tube wall of the tube which surrounds the longitudinal axis of the tube;
wherein the apparatus further comprises a holding device, and
wherein the tube is mounted with the first and second ends on the holding device so as to be rotatable about the longitudinal axis of the tube, so that a hanging part of the climbing plants can be wound up over the at least one tube.

21. The apparatus according to claim 20, wherein the at least one tube is arranged with an angle of inclination (w) to a horizontal direction (x) which is greater than or equal to 1 degree.

22. The apparatus according to claim 20, wherein the at least one tube has a first end opening at its first end and a second end opening at its second end, wherein the apparatus comprises an irrigation unit with which nutrient solution can be introduced into the tube through the first end opening, wherein the apparatus further comprises a collecting element.

23. The apparatus according to claim 22, wherein the collecting element is arranged below the second end opening in such a way that nutrient solution exiting through the second end opening can be collected in the collecting element.

24. The apparatus according to claim 22, wherein the irrigation unit comprises a pump, a first conduit, and a tank, wherein the pump is adapted to deliver the nutrient solution from the tank through the first conduit to the first opening.

25. The apparatus according to claim 24, wherein the irrigation unit comprises a second conduit with which the nutrient solution collected in the collecting element can be returned to the tank.

26. The apparatus according to claim 20, comprising a plurality of tubes arranged vertically one above the other.

27. The apparatus according to claim 26, wherein the tubes are arranged with tube axes parallel to each other.

28. The apparatus according to claim 26, comprising a transport unit configured to move the tubes in the vertical direction (y).

29. The apparatus according to claim 28, wherein the transport unit has two tension transmission devices wherein a first of the tension transmission devices extends at least in sections in the vertical direction (y) at the first ends of the tubes, and wherein a second end of the tension transmission devices extends at least in sections in the vertical direction (y) and parallel to the first tension transmission device at the second ends of the tubes.

30. The apparatus according to claim 29, wherein the first tension transmission device runs over a first and a second deflection roller, and the second tension transmission device runs over a third and a fourth deflection roller.

31. The apparatus according to claim 29, comprising at least one motor which is configured to drive at least one of the deflection rollers in such a way that the tubes can be moved in the vertical direction (y).

32. The apparatus according to claim 20, wherein the tubes are each arranged at their first and second ends on the corresponding tension transmission device via a retaining element,
wherein the retaining elements each have two legs adjoining each other at a non-vanishing angle, and
wherein one of the legs is arranged on the corresponding tension transmission device via a bearing, and wherein the corresponding tube is arranged on the other of the legs via a swivel joint.

33. A method of cultivating climbing plants using an apparatus according to claim 20, comprising the following steps:
inserting at least one climbing plant into at least one of the at least one opening of the at least one tube; and
rotating the at least one tube about its tube axis in order to wind a hanging part of the climbing plant over the at least one tube.

34. The method according to claim 33, wherein the at least one tube is rotated in such a way that the at least one opening for inserting climbing plants is located in a lateral or upper tube region after the rotation.

35. A system for cultivating and harvesting climbing plants, comprising:
an apparatus according to claim 20;
an illumination device for illuminating the climbing plants, which is arranged on a first side of the apparatus; and
a harvesting robot for harvesting the climbing plants, which is arranged on a side of the apparatus opposite the first side.

36. The system according to claim 35, wherein the harvesting robot is designed for harvesting the climbing plants on the side of the apparatus opposite the first side and/or for harvesting the climbing plants on the first side of the apparatus.

37. The system according to claim 35, comprising a further harvesting robot for harvesting climbing plants.

38. The system according to claim 37, the further harvesting robot is for climbing the shoot tips of the climbing plants, which is arranged on the first side of the apparatus between the illumination device and the apparatus.

39. A method for cultivating and harvesting climbing plants by utilizing a system according to claim 35, comprising:
inserting at least one climbing plant into at least one opening of the at least one tube;
illuminating the at least one climbing plant on a first side of the apparatus;
harvesting the at least one climbing plant on the side of the apparatus opposite the first side; and
rotating the at least one tube in order to wind at least one harvested hanging part of the at least one climbing plant over the at least one tube.

40. The method according to claim 39, further comprising harvesting the shoot tips of the climbing plants on the first side of the apparatus.
